(19) United States
(12) Patent Application Publication
(10) Pub. No.: US 2009/0279676 A1
(43) Pub. Date: Nov. 12, 2009

(54) SYSTEMS AND METHODS FOR DELIVERING COMPUTER IMPLEMENTED VOICEMAILS

(76) Inventor: Nicholas Zazza, Freehold, NJ (US)

Correspondence Address: MEREDITH & KEYHANI, PLLC, 330 MADISON AVE., 6TH FLOOR, NEW YORK, NY, 10017, US

(21) Appl. No.: 12/052,669

(22) Filed: Mar. 20, 2008

Related U.S. Application Data
(63) Continuation-in-part of application No. 11/877,638, filed on Oct. 23, 2007.
Application No. 11/877,638 is a continuation-in-part of application No. 11/877,640, filed on Oct. 23, 2007.

(51) Int. Cl. H04M 1/64; H04L 12/66

(52) U.S. Cl. 379/88.17; 370/352

(57) ABSTRACT

A computer implemented method of sending a voicemail, the method comprising the steps of: providing a first user having a first user ID associated with a first phone number; accepting an voicemail request from the first user containing at least one email address; receiving in a computer based system the voicemail request and the computer based system places a telephone call to the first phone number; playing an advertisement to the first user; recording a voicemail from the first user; and emailing an email containing at least one word of transcribed text from the voicemail to the email address.

This application is a continuation in part and claims priority to patent application Ser. Nos. 11/877,638, 11/877,640 and 11/877,642 filed Oct. 23, 2007 which are incorporated herein by reference.

The present invention relates generally telecommunications and more specifically to systems and methods for emailing voicemails.

Typically, phone calls are made by one user dialing the telephone number of a second user. However, it would be desirable to be able to email a voicemail for many reasons. For example, if you know that the user is in a meeting where they can check emails on their handheld device, but cannot call into their voicemail.

Accordingly, the present invention provides systems and methods for providing computer implemented voicemails.

### SUMMARY OF THE INVENTION

The present invention relates generally telecommunications and more specifically to systems and methods for emailing voicemails.

According to one embodiment, a computer implemented method of sending a voicemail through a web page input, the method comprising the steps of: providing a first user having a first user ID associated with a first phone number; accepting an voicemail request from the first user containing at least one email address; receiving in a computer based system the voicemail request and the computer based system places a telephone call to the first phone number; playing an advertisement to the first user; recording a voicemail from the first user; and emailing an email containing at least one word of transcribed text from the voicemail to the email address.

According to another embodiment, a system for sending a voicemail through a web page input is provided, the system comprising: at least one initiating phone apparatus; at least one master database; at least one server farm; at least one text server farm; a web page; at least one queue monitoring farm; at least one advertisement storage server; at least one voicemail storage server; wherein a first user having a first telephone number inputs a voicemail request into at least a portion of the webpage including a destination email address, the at least one text server farm determines at least one available server in the at least one server farm, the available server accepts the voicemail request and determines from the master database the first user's plan and determines the advertisement status, the voicemail request and the advertisement status is placed in the queue monitoring farm, the at least one server farm calls the first telephone number, plays an advertisement according to the advertisement status, upon completion of the advertisement the at least one server farm accepts and records a voice recording from the first user, the voice recording is transcribed to provide a transcribed voicemail and the transcribed voicemail is sent by email to the destination email address.

These and other features, aspects and advantages of the present invention will become better understood with reference to the following description and claims.

### BRIEF DESCRIPTION OF THE DRAWINGS

FIGS. 1-34 depict the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

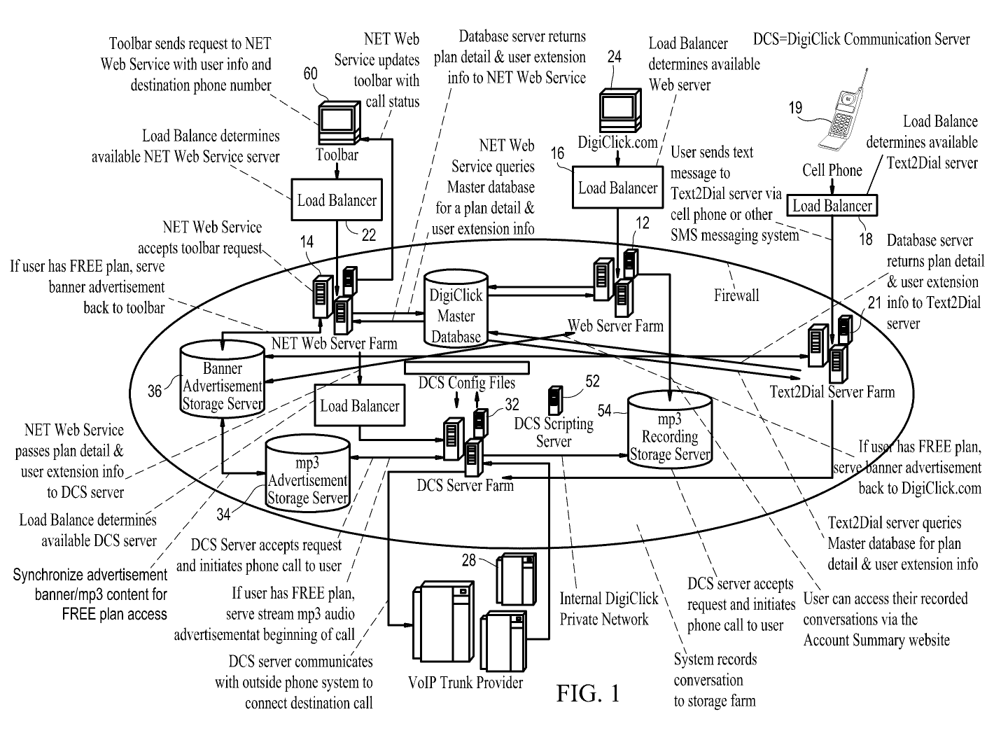

FIG. 1 depicts a system for providing anonymous calling as in the present invention. The system comprising: a master database (10); at least one server farm (12, 14, 32); at least one load balancer (16, 18, 20, 22); a web page (24); config files (26); VoIP trunk provider (28); at least one advertisement storage server (34, 36); and wherein a first user performs a call request, one of the load balancers (16, 18, 20, 22) determines the available server in the server farm (12, 14, 32) the available server accepts the call request and determines from the master database (10) the first user's plan. If the first user has a free plan, the at least one advertisement storage server (34, 36) calls the first user and plays the advertisement (which may be, for example, an audio, video or banner advertisement). The load balancer (20) determines the available server in the at least one server farm (32) and the at least one server farm (32) accepts and records a voicemail. The call request may be accepted through a toolbar (50) on a user's computer and may be via short message service (SMS). The call request may also be accepted though an input device, such as mobile phone (19) via text message, in which case a load balancer (18) determines the available server on a second server farm (21). There may also be a scripting server (52) for providing messages to users. For example, if the first user texts a userID that is unknown, the system may play a message that says, “User id unknown”. After the system accepts the call request, it will call the first user and an voicemail recording storage server (54) for will record the voicemail. The system transcribes the voicemail into text and email the text to the email provided.

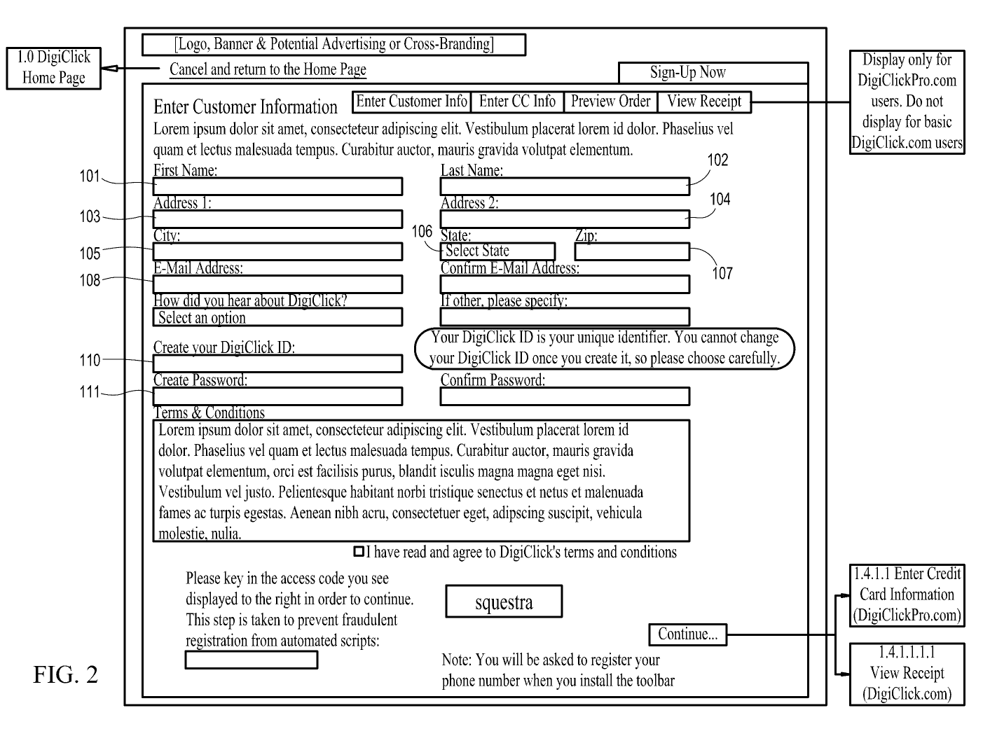

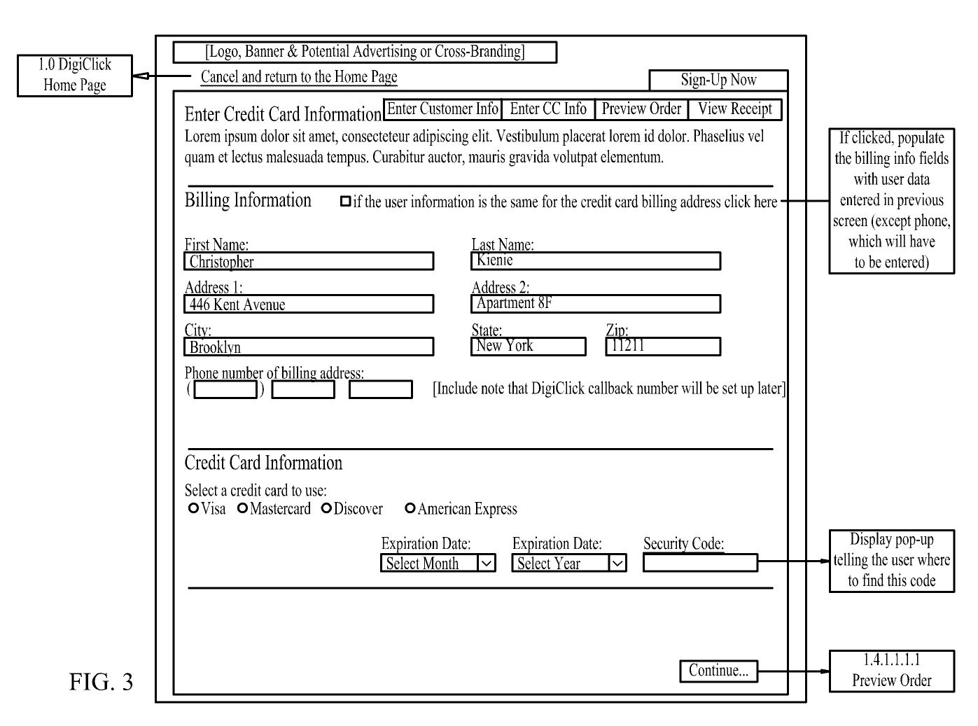

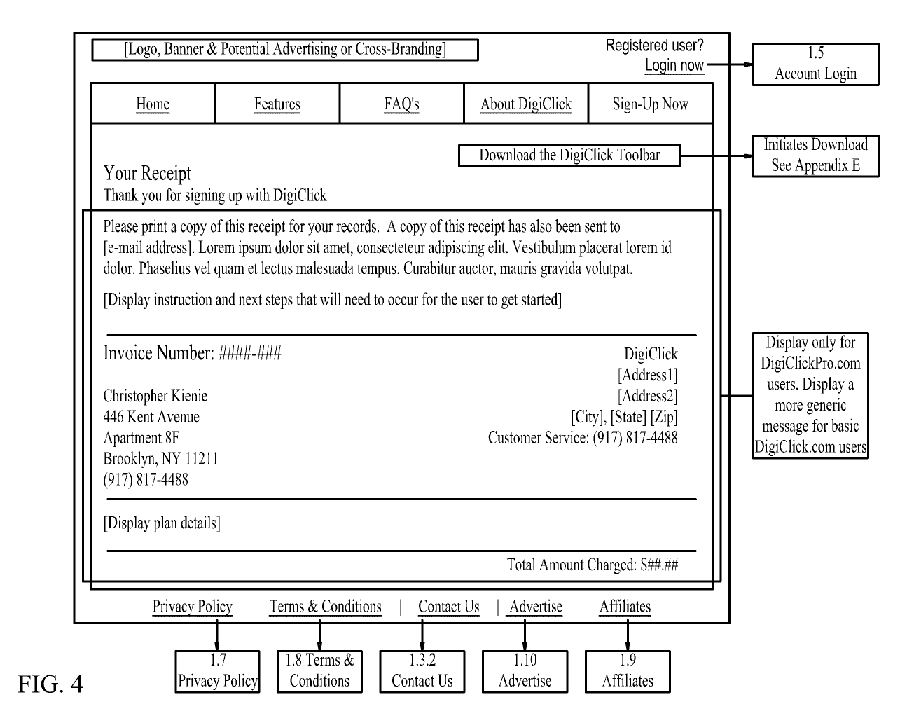

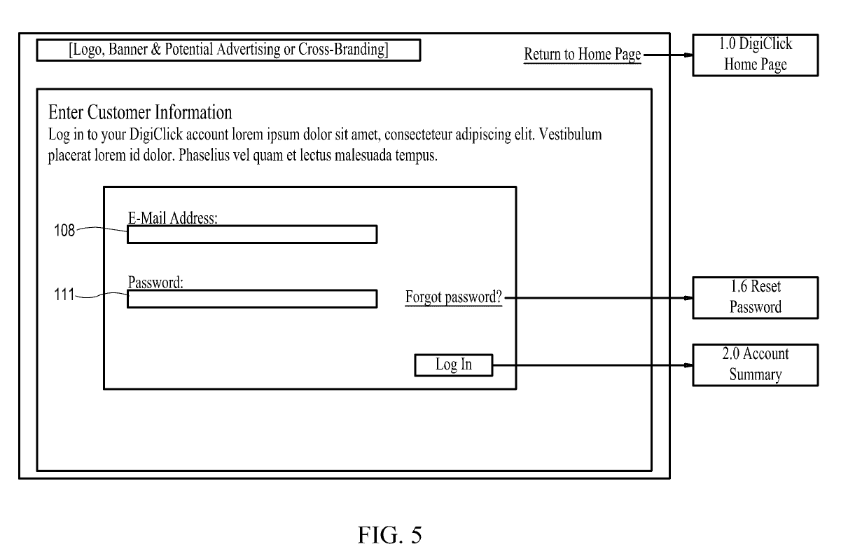

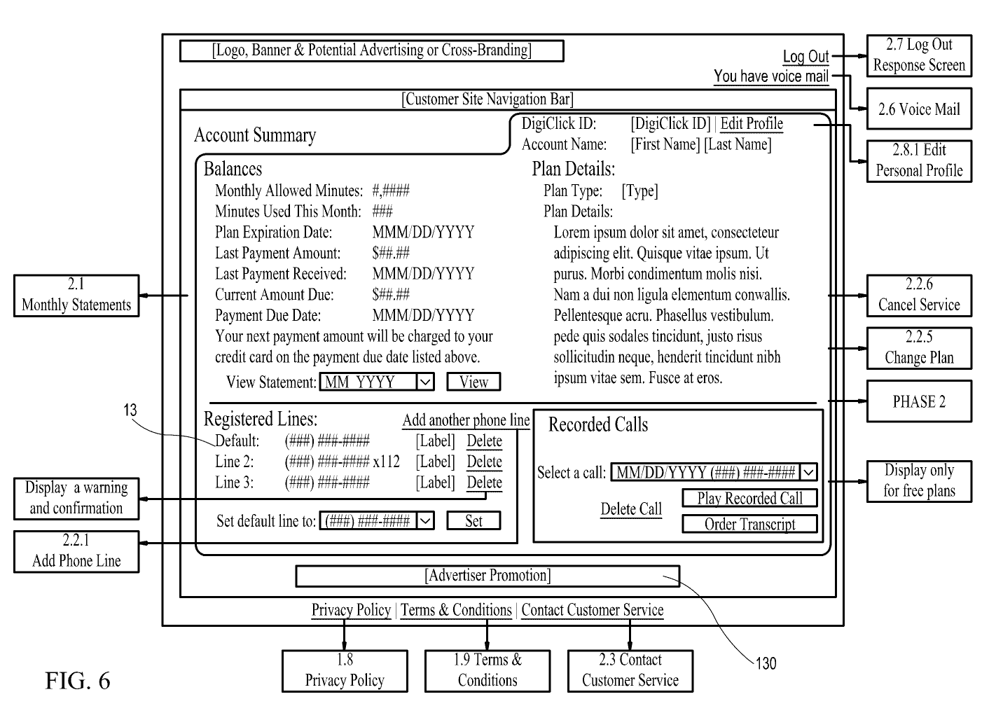

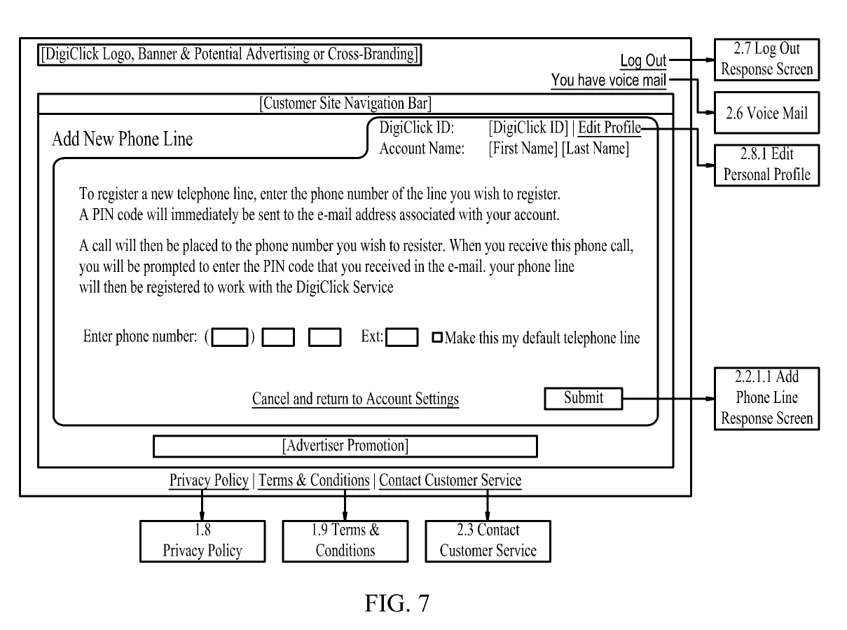

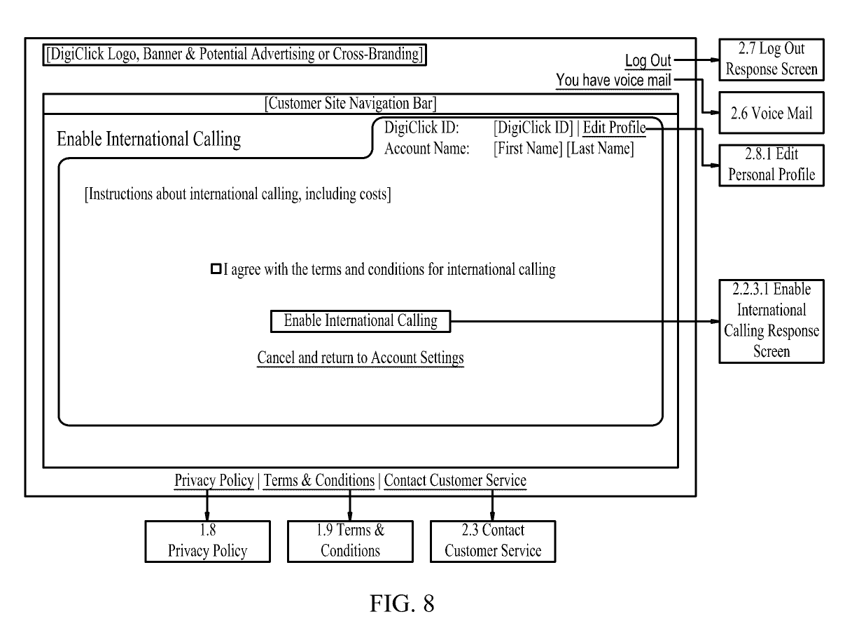

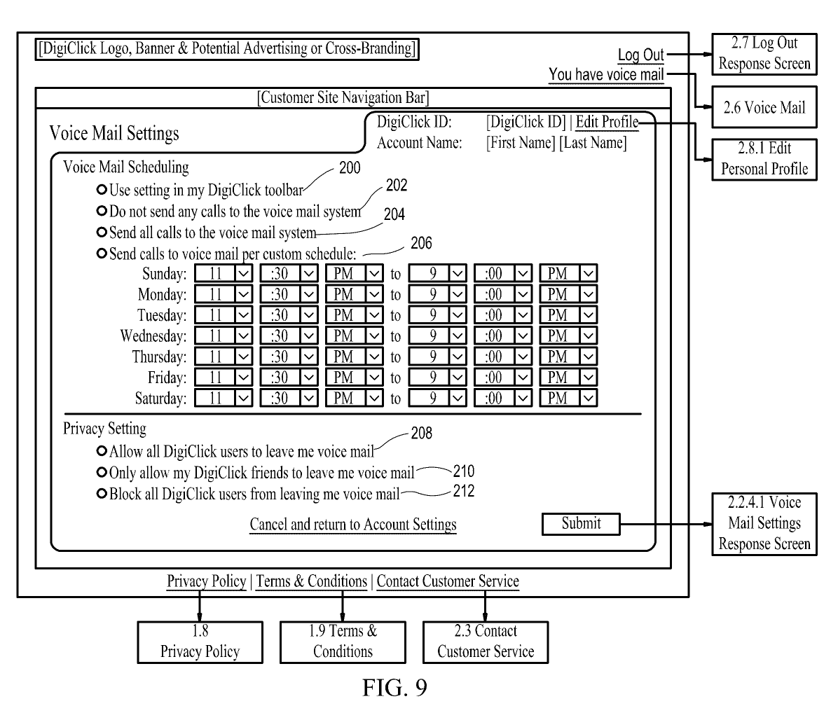

A first user having a first user ID associated with a first phone number. FIG. 2 depicts how a first user may obtain a first user ID. The user may go to a web site, and input their first name (101), last name (102), address1 (103), address2 (104), city (105), State (106), zip (107), email address (108), firstuser ID (110), password (111). The first user may enter into a paid plan or a free plan. If the first user enters into a paid plan, they are required to input their billing information, as shown in FIGS. 3-4. A call may be initiating by a call requests in a number of different ways. There may be a toolbar (50) installed on the first users computer, The user may login, as shown in FIG. 5 by entering their email address (108) and password (111). As shown in FIG. 6, advertisements (130) may be played throughout the users account pages. There may also be a number of different phone numbers (132) associated with a user id. The user selects a first phone number, though for calls to be received on. This may be changed through the website interface. It is also envisioned that different call features may be used to reach the first user, but at least one first phone number is associated with the first user ID. For example, the first user ID may be associated with three registered lines and ring at all three simultaneously, or call each phone number in order ringing three rings, if unanswered then going to the destination phone number and ringing three rings and if unanswered ringing at the third phone number. At any point, a new phone line can be added (as shown in FIG. 7) or removed. Also, the first user may enable international calling, as shown in FIG. 8. As shown in FIG. 9, the voicemail may also be set according to the user's preferences. For example, the user may request to use setting in the toolbar (200), do not send any calls to the voice mail system (202), send all calls to the voice mail system (204), send calls to voice mail per custom schedule (206). The user may also select privacy settings, such as allow all registered users to leave voicemails (208), only allow my registered friends to leave voicemail (210), block all registered users from leaving voice mail (212).

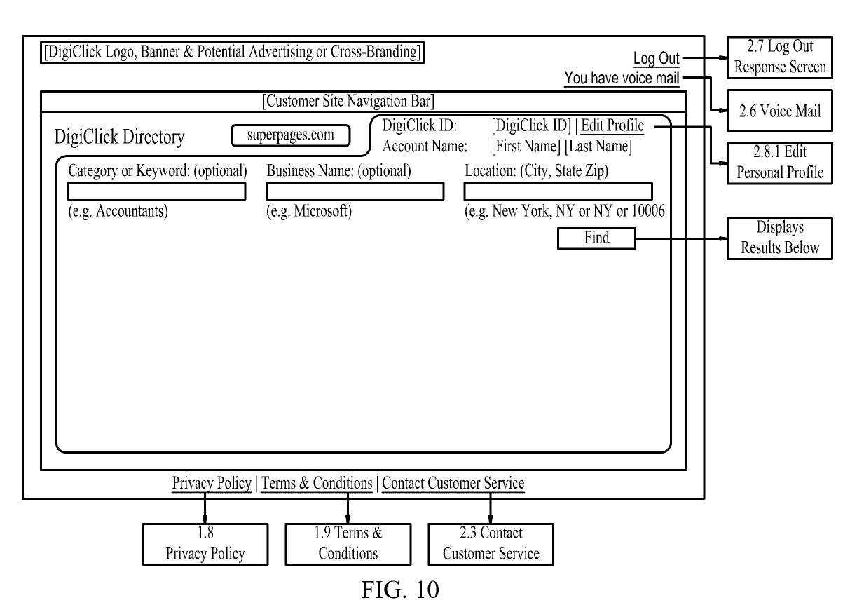

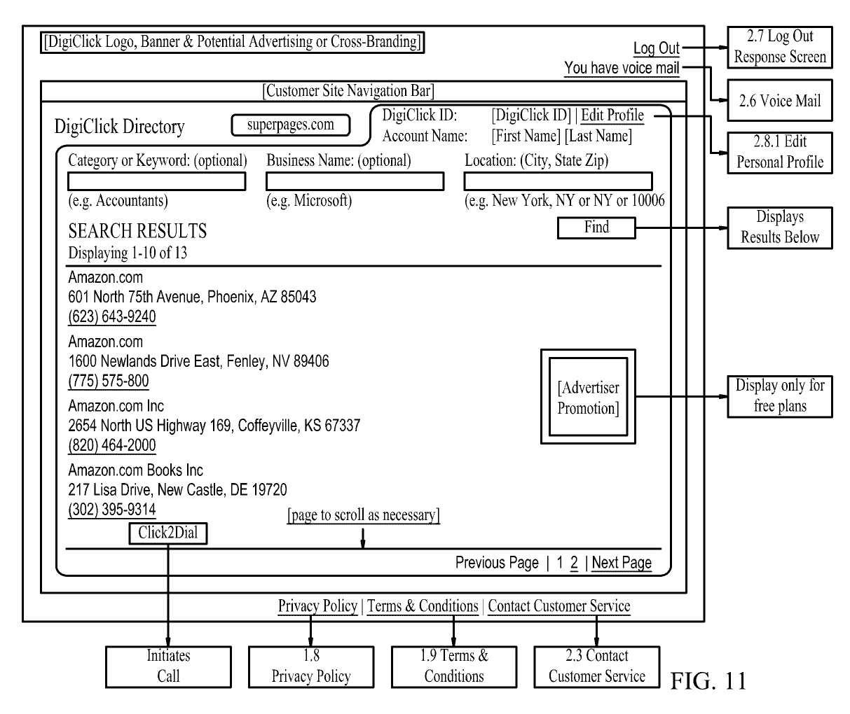

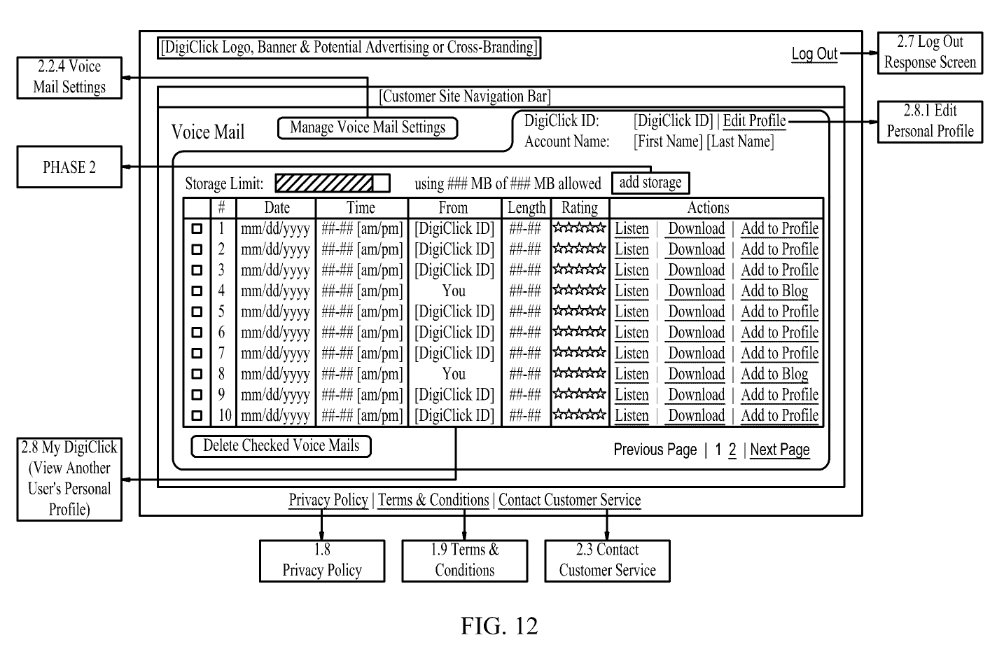

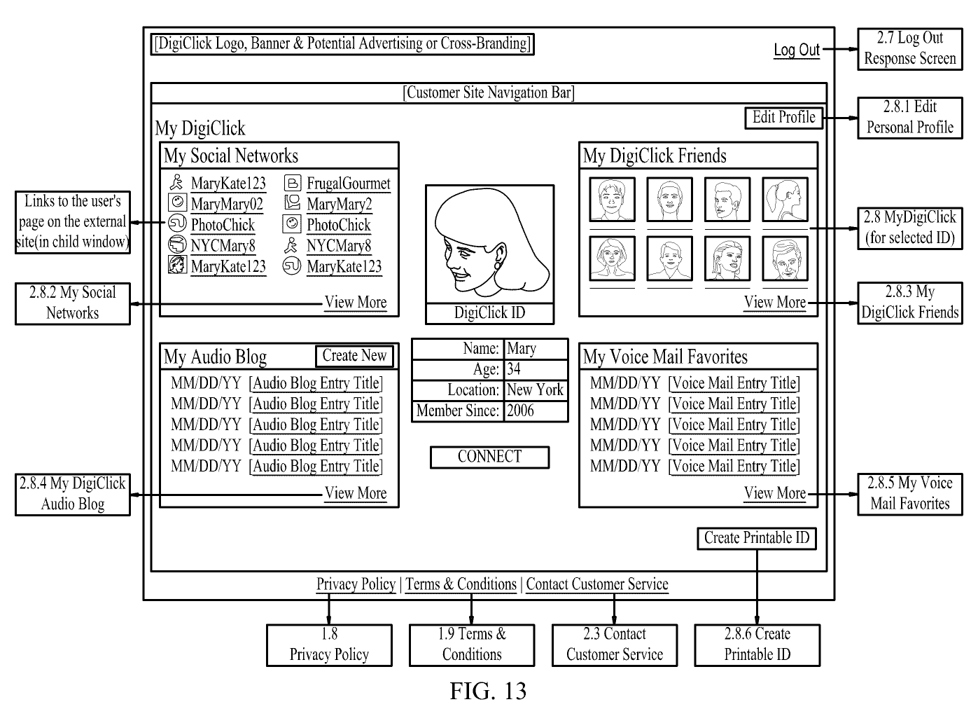

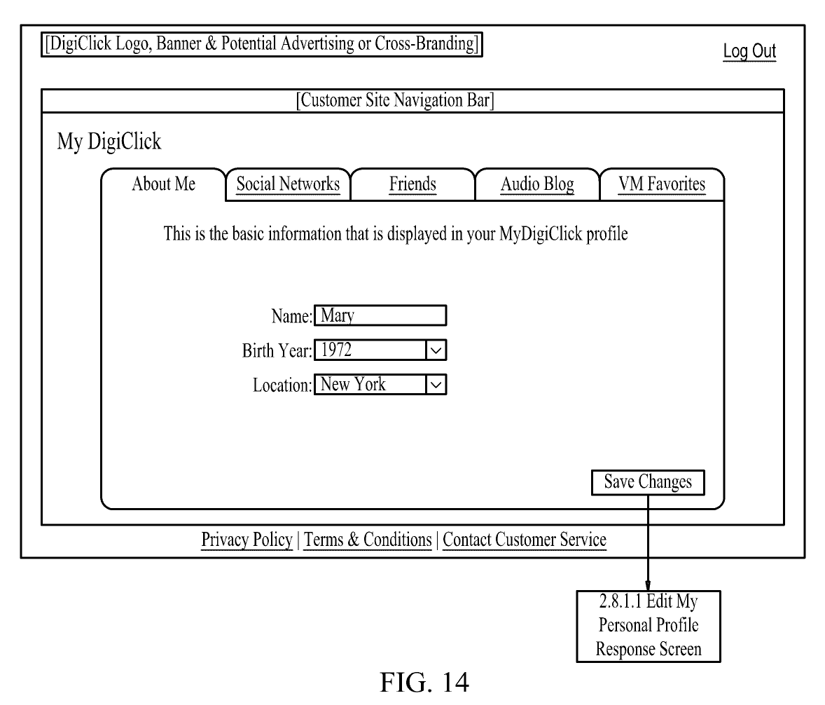

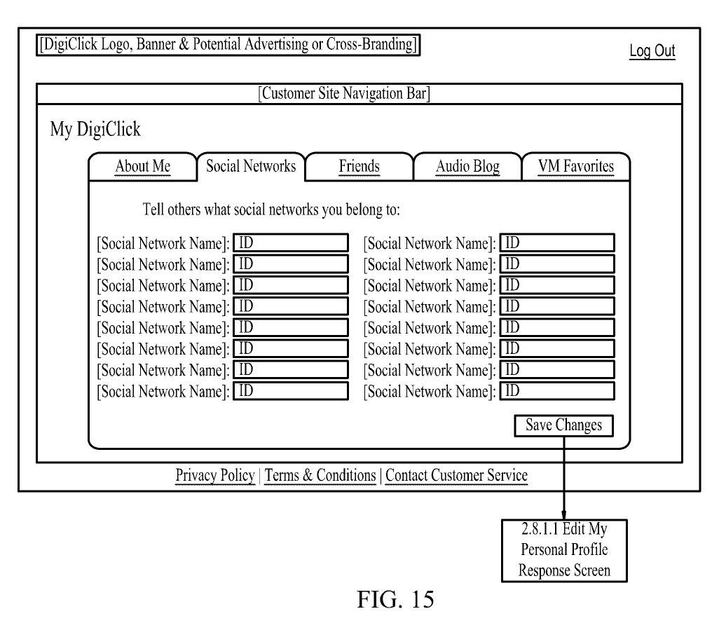

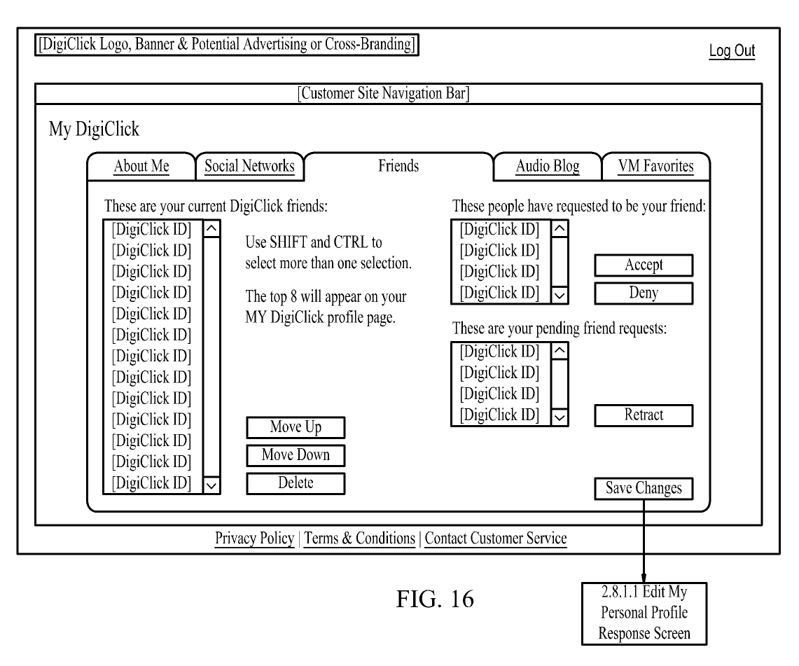

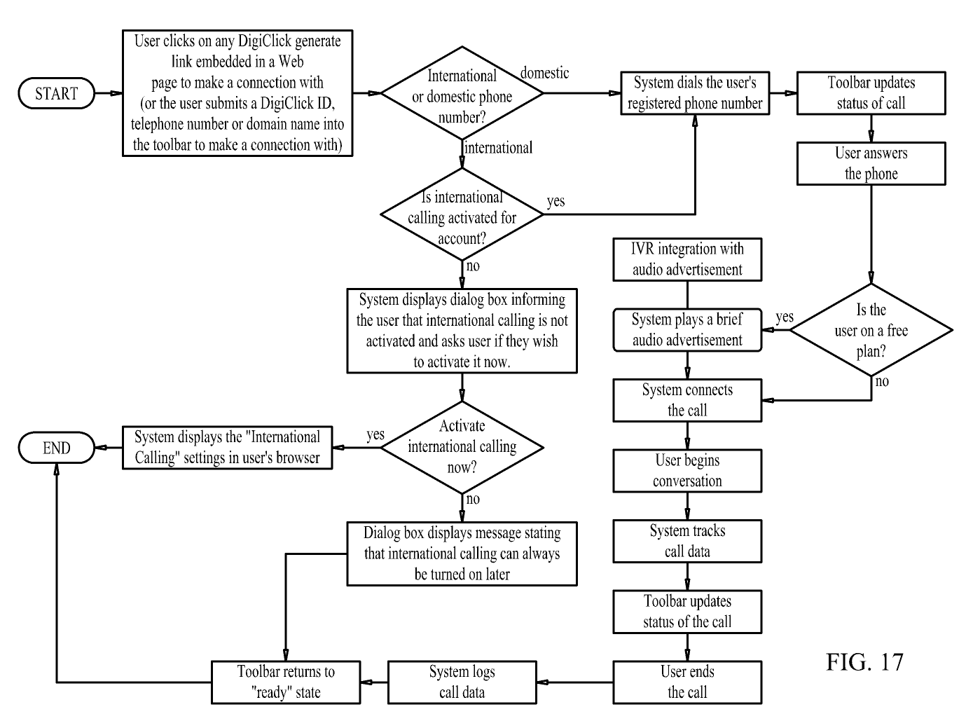

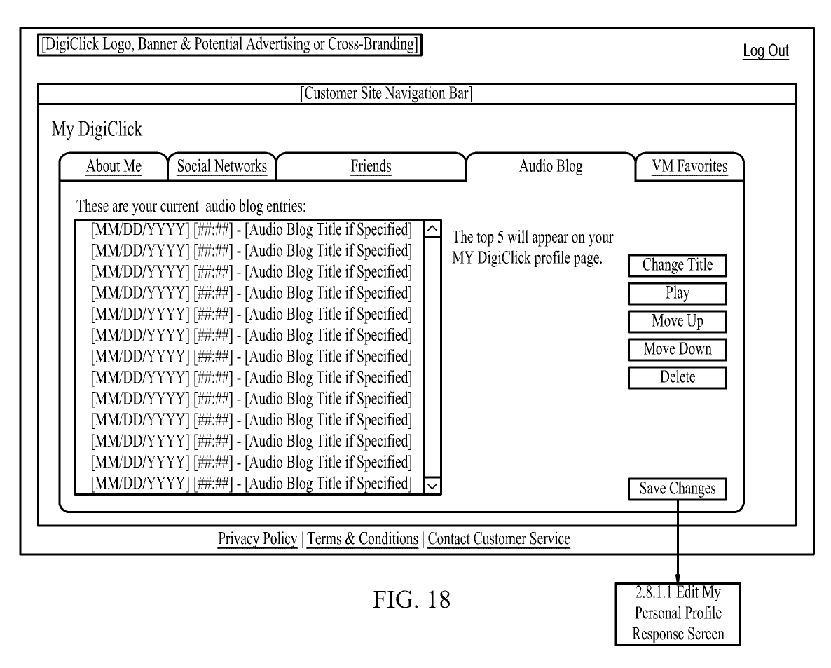

As shown in FIGS. 10-11, there may be a registered user directory showing companies and/or individuals by userID. It may be searched by business type and serve as advertising for the businesses. In this way, user can just click on the business userid, their telephone will ring and the business telephone will ring to connect the user with the business they wish to reach.

The present invention may also utilize advertisements to defray costs. The advertisement may be played on the first users mobile phone, any hand held device or computer, or any of these methods simultaneously depending on the advertiser and whether the first user is inputting the call request in their computer or their telephone via text message. Then the step of calling the first user and accepting the voicemail is performed. The call to the first user could be by a mobile phone, a VoIP phone, a standard land line or any technology the user prefers.

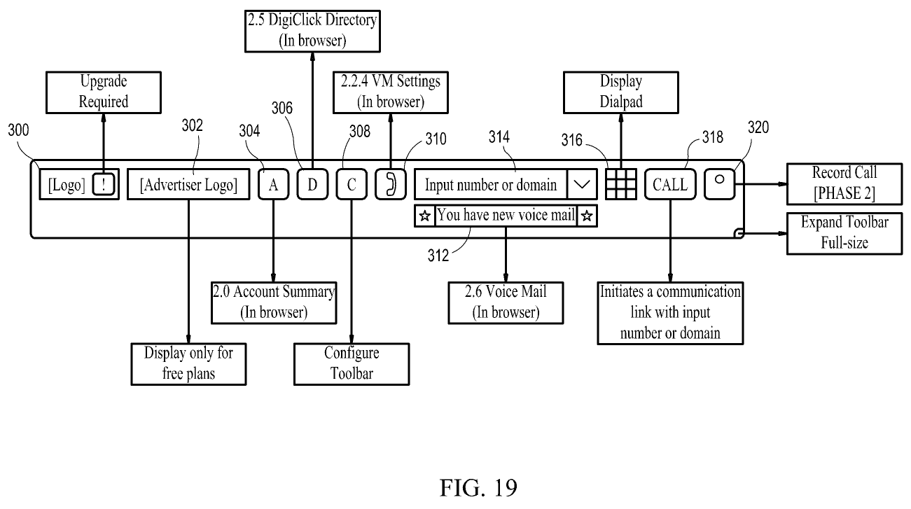

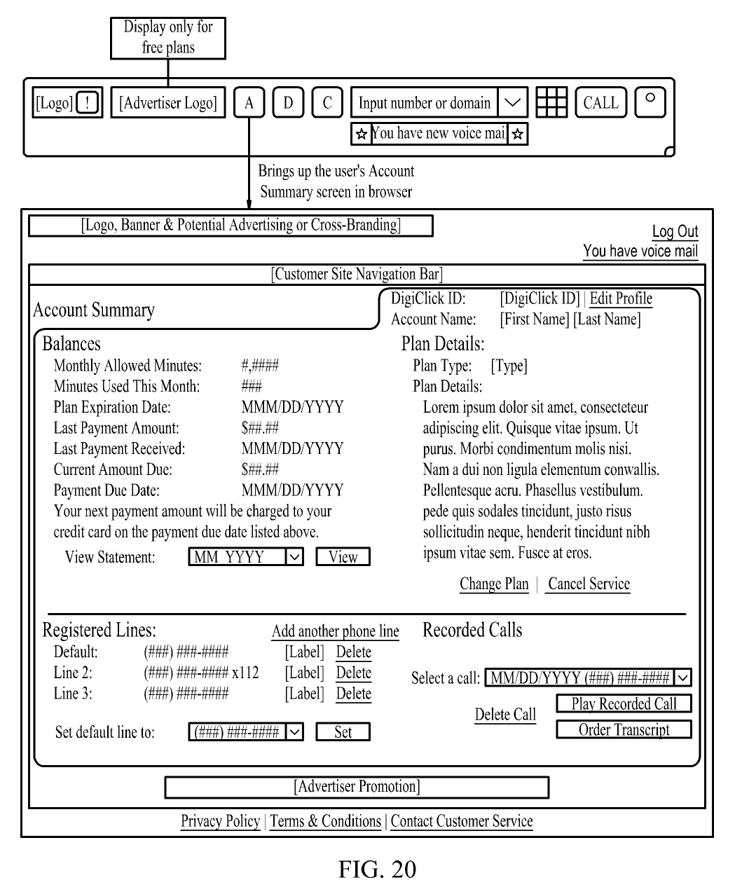

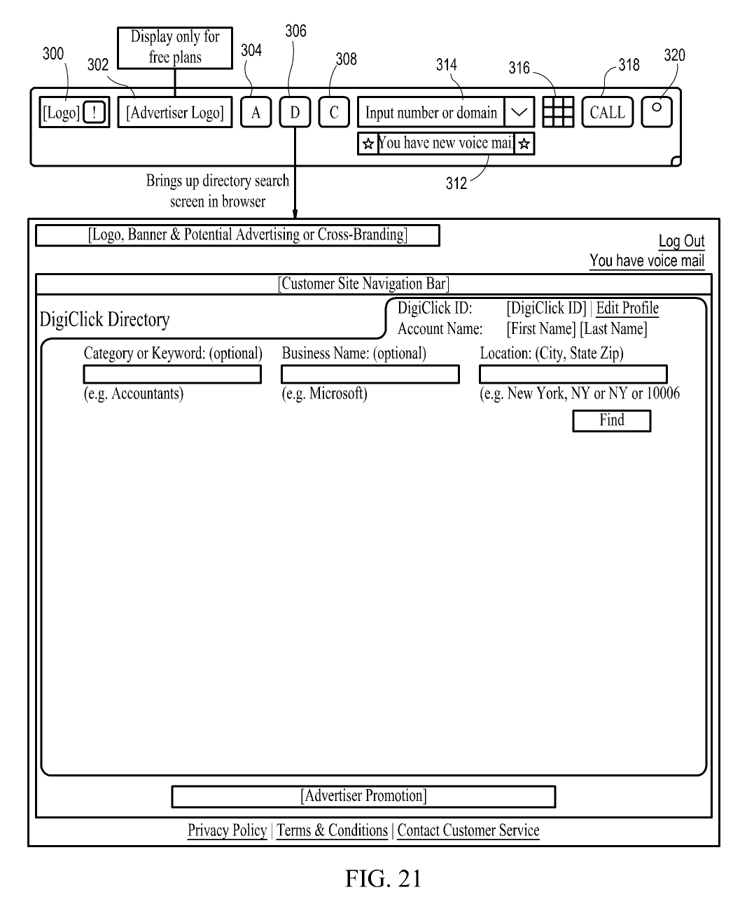

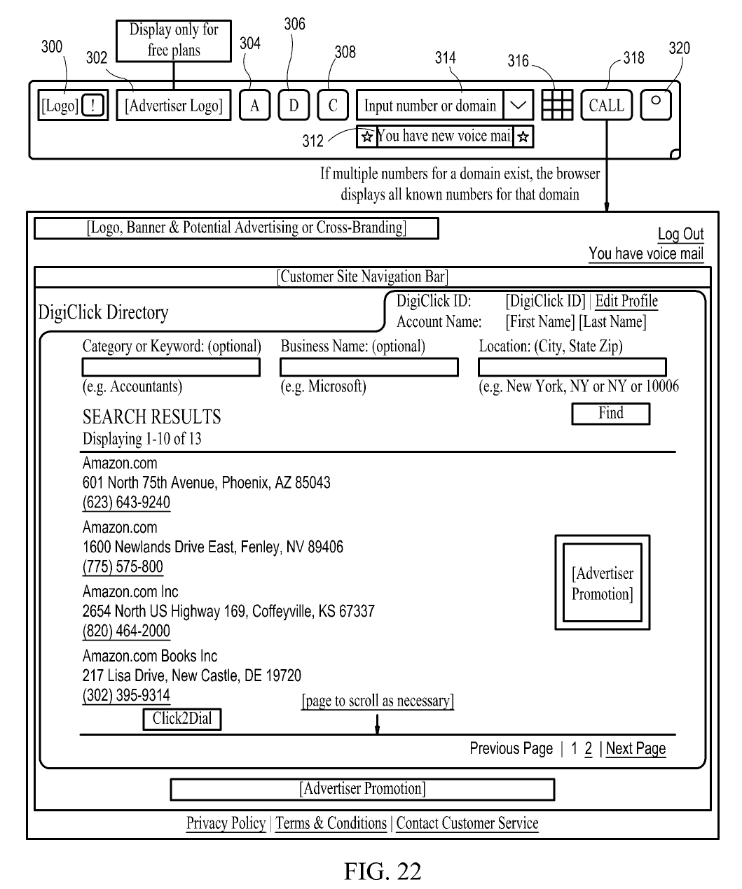

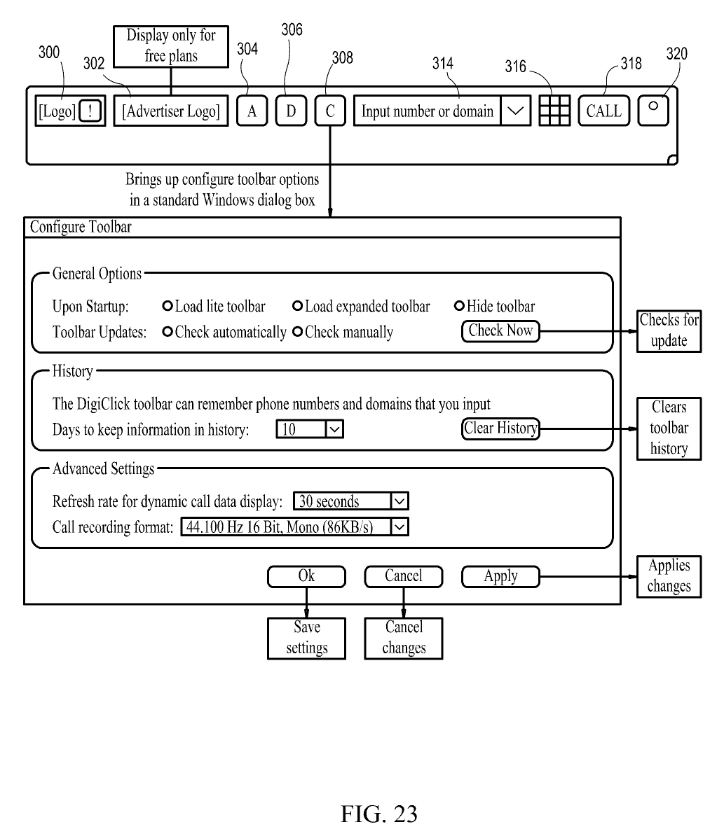

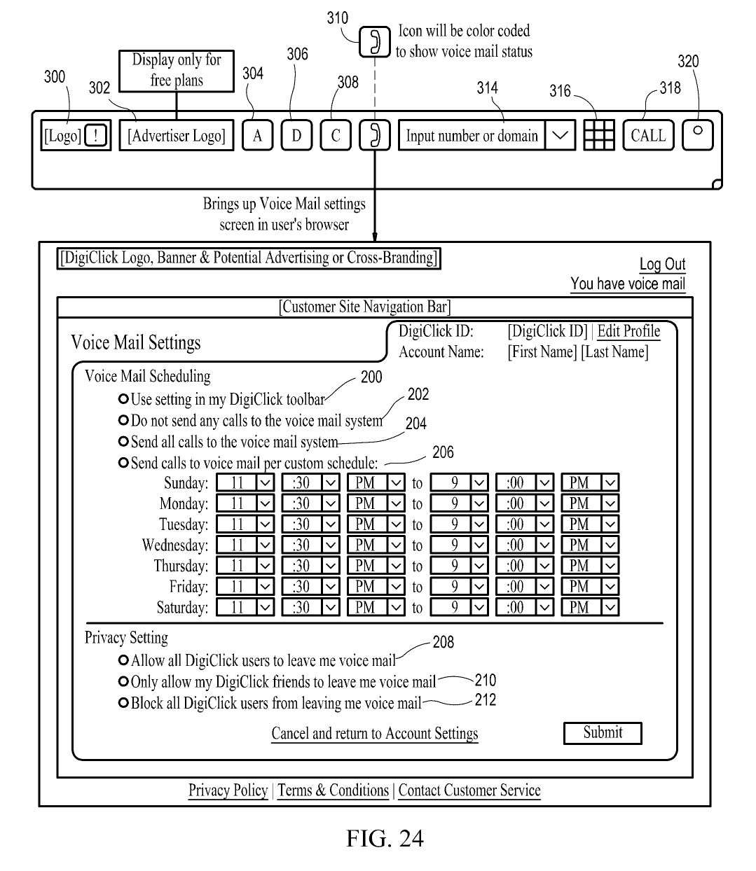

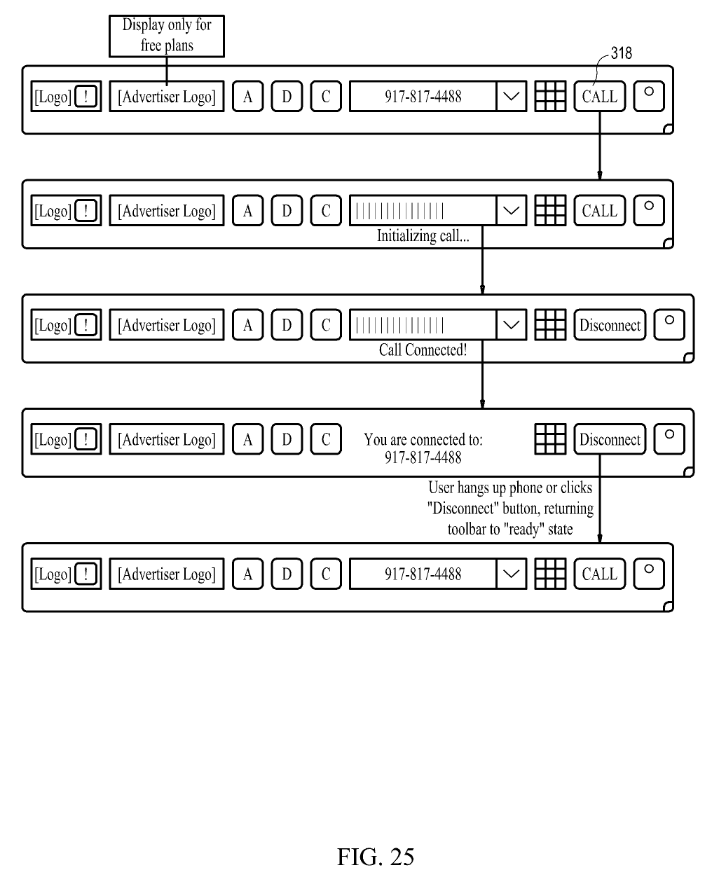

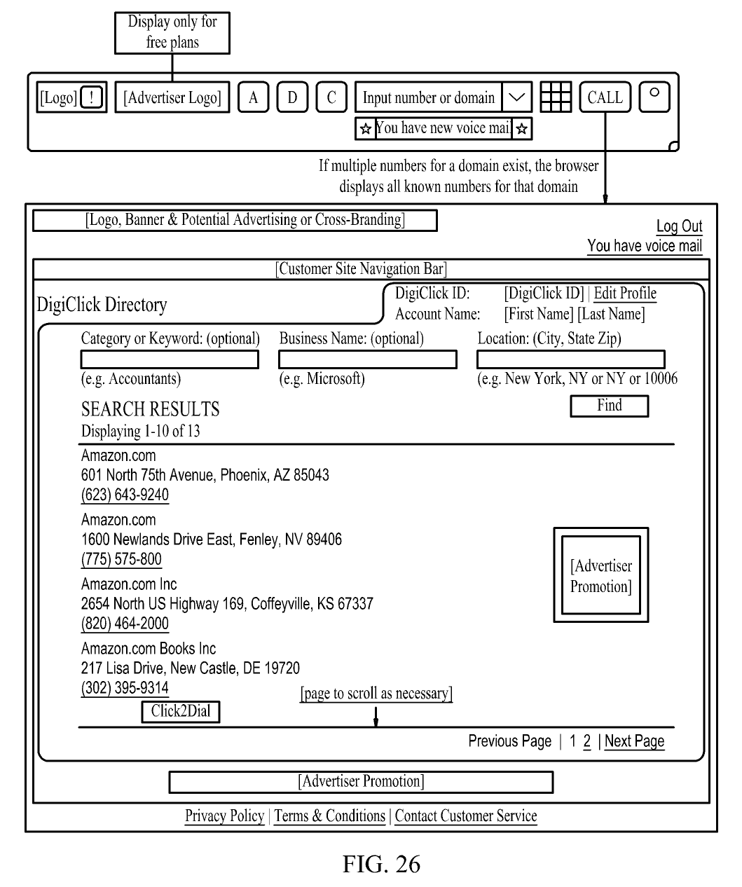

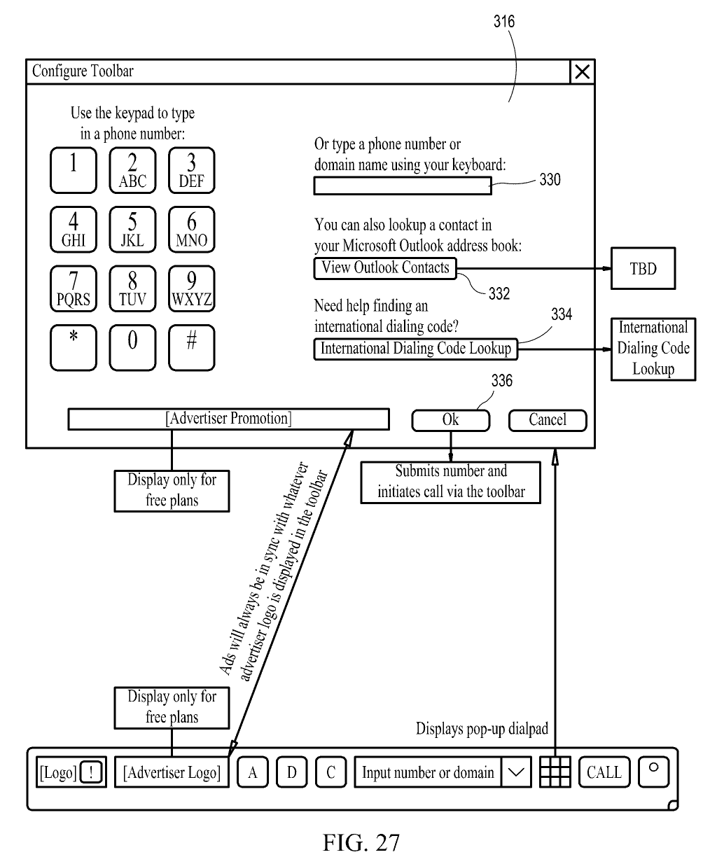

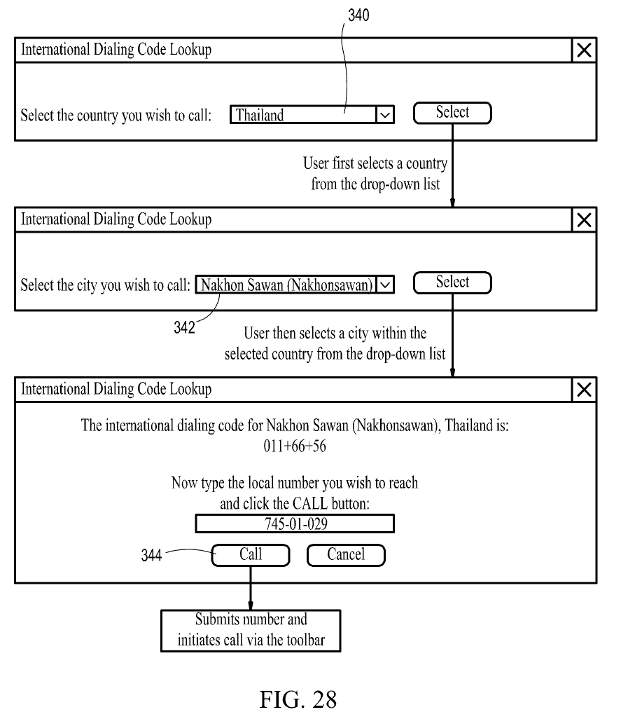

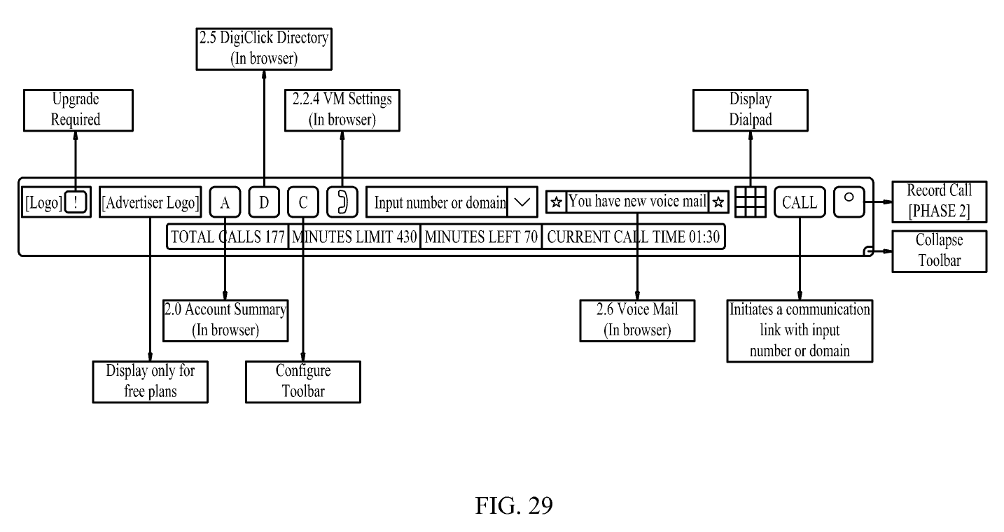

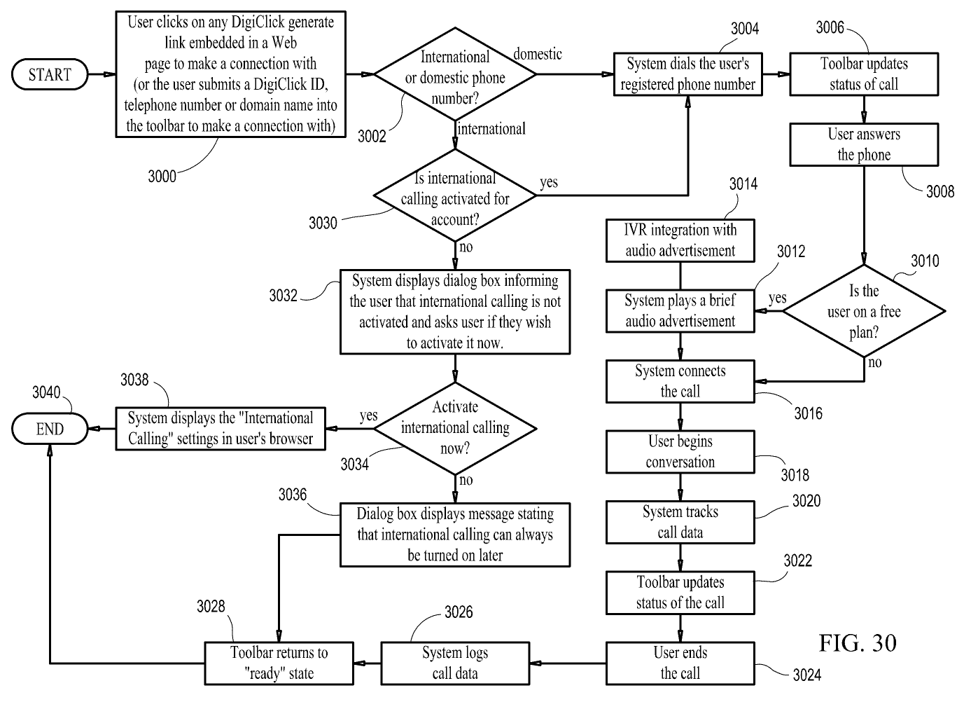

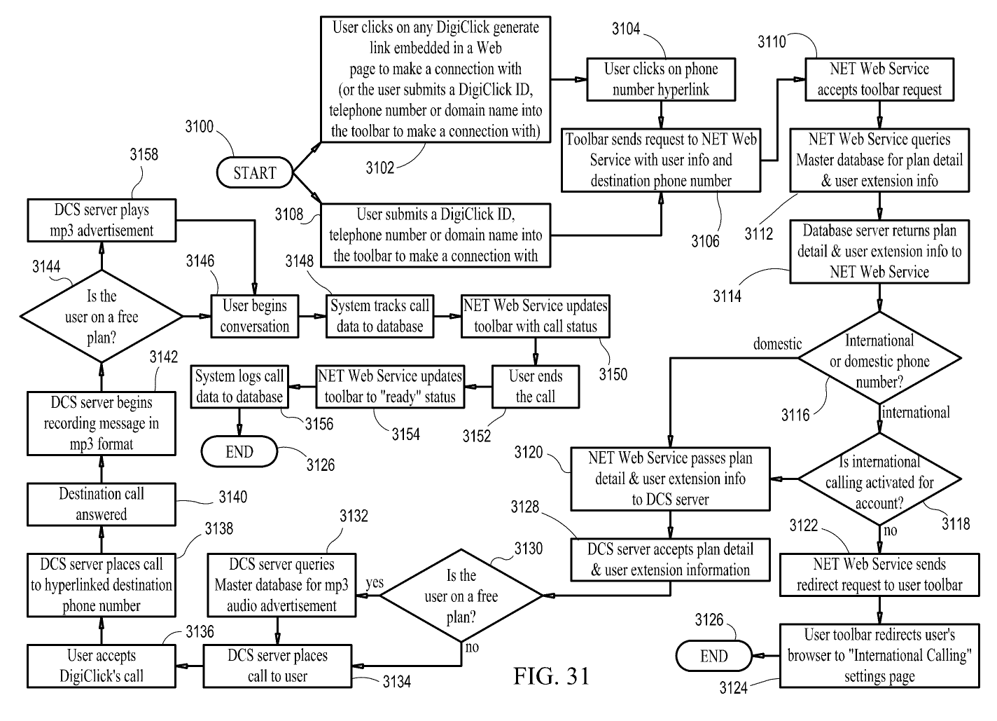

The present invention also envisions a call center, in which users can track voicemails, calls and emails. Also, the toolbar of either user may update according to the status of the anonymous phone connection. FIGS. 19-29, depicts a toolbar according to the present invention. As shown, there may be a logo (300), an advertiser logo (302), account summary (304), directory (306), configure toolbar (308), voicemail settings (310), voicemail (312), drop down of input number or domain (314), display dialpad (316), record button (320). FIG. 20 depicts a screenshot of what may happen when you click on the account summary (304) button. FIG. 21 depicts a screen shot of what happens when you click on the Directory (306) button. FIG. 22 depicts the call (318) button screenshot. FIG. 23 depicts a screen shot of the configure toolbar (308). FIG. 24 depicts the voicemail settings (310) screen shot. FIG. 25 depicts the step of updating the toolbar according to the status of the phone connection. As shown, the user may click on the call (318) button. The drop down of the input number or domain or user id (314) may then indicate that the computer based system is initiating the call. At this point the toolbar display changes to show the call status and the call (318) button may change to say disconnect and show the number that the user is connected to. When the user hangs up the call button (318) may switch back to say call and numbers and or userID's may be stored in the drop down (314). FIG. 27 depicts the dialpad (316). As shown, you call dial in the numbers, type in the phone number or userID (domain) (330), you can also lookup a contact in your Microsoft outlook or other program (332), also you can connect to an outside or internal directory (334). FIG. 28 depicts a country code lookup, you can input the country you wish to call the city and input the local number (334) and press call (344). The computer based system will formulate the number to call and call the first user and the second user to connect the callers. FIG. 39 depicts a sample flowchart of a call from the toolbar and/or dialpad (316). The data regarding the length of the call and an audio clip of the actual phone connection may be stored on either users account and viewable on their webpage. Also there may be the step of updating the toolbar of the first user according to the status of the anonymous phone connection.

It may also be necessary to provide the step of: determining the destination phone number locale status, wherein the destination phone number locale status is either domestic or international; wherein the destination phone number locale status is international, the method further comprises the step of determining the initiating users membership status, the initiating users membership status being selected from the group consisting of registered and paying, registered and free or unregistered; and wherein the membership status is registered and paying the step of calling the destination phone number is completed; wherein the membership status is registered and free the step of playing an advertisement to the user is performed and the step of calling the destination phone number is completed; wherein the membership status is unregistered, the initiating user is directed towards a membership application and the step of calling the destination phone number is not completed until the membership status is either registered and paying or registered and free. The advertisement when the phone number locale status is international may be a longer advertisement or a more expensive advertisement. Also, the user may chose not to activate international calling and may be provided with a message that international calling may be turned on at a later time, the tool bar returns to ready status and the process is ended. The method may also comprise the step of accepting an input from the first user's phone in response to the step of playing an advertisement. For example, the ad may say “American Airlines e-savers for this week are $69 from New York to Los Angeles, press “1” to make a reservation”. This may be accomplished via IVR integration with the audio advertisement The system presents IVR system menu. The user may press or say 1. The system requests advertiser's information template, looks up subscriber's email address, IVR plays configuration of the request as the systems emails the advertisers information to subscriber. If the user selects “2”, the system requests advertisers preset telephone number, the system connects user with the advertisers preset number. If the user selects “3”, the system request the advertisers URL, the system sends the request to the .NET services, the .NET services sends command to the toolbar, IVR plays audio confirmation of the request as the user's toolbar opens the advertisers website is in a new window. If the user selects “3”, the DCS requests advertiser's URL, DCS sends request to .NET services, .NET services sends command to toolbar, IVR plays audio confirmation of the request as the user's toolbar opens the advertisers website in a new window. As in any of the phone connections, it is envisioned that the method may comprise the step of recording the anonymous phone connection and providing information on all phone connections such as the length of the call.

The toolbar may parse the web page to make all emails clickable voicemail hyperlinks. The user may click on the email hyperlink. Alternatively, the user may submit a email address and/or domain name to make a connection with. The toolbar sends the request to the .net web service with user info and first user phone number. The .net web service accepts the request. The .net web service queries the mater database for plan detail and user extension info. The database server returns plan detail and user extension for to the .net web service and determines if the call is domestic or international. If the call is domestic, the .net web service passes plan detail and user extension info to the system server. The system server accepts the plan detail and user extension information. If the user is on a free plan, the system server queries the Master database for an .mp3 audio advertisement. Then the system server places the call to the first user. The first user accepts the call, the system server accepts a voicemail recording (there may be the step of playing an advertisement to the first user prior to this step). The server may recording in .mp3 format. The systems tracks call data and sends to the database, the .net web service updates the toolbar with call status. When the user ends the call, the .NET web service updates the toolbar to “ready” state, the system logs the call data to the database and the call is ended.

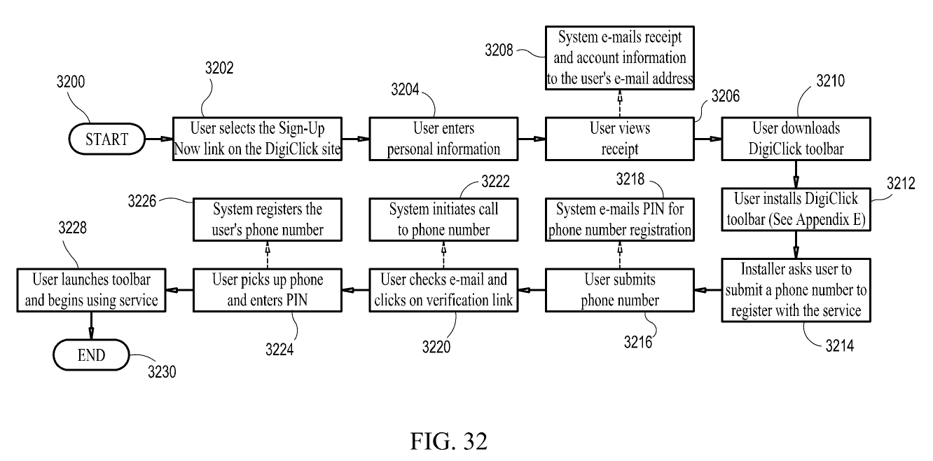

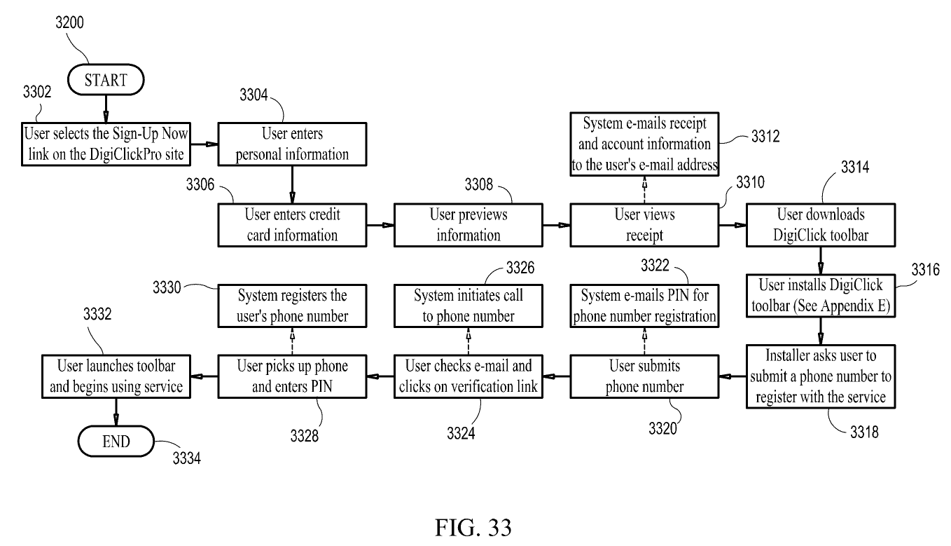

FIGS. 32-33 depicts the process of signing up to be a registered user. As shown, the user selects the sign-up now link on the website (3202). The user enters their personal information (3204). The user views the receipt (3206). The system emails receipts and information to the users account (3208). The user may also download the digiclick toolbar (3210). The user may install the toolbar (3212). The installer asks to submit a phone number (3214). The user submits a phone number (3216). The system emails a PIN for phone number registration (3218). The user checks email and clicks on verification link (3220). The system initiates call to phone number (3222). The user picks up phone and enters pin (3224), the system registers the user's phone number (3226). The user launches the toolbar and begins using service (3228). FIG. 33 depicts a higher level or Digiclick Pro account. As shown, the user selects the sign-up now (3302). The user enters information (3304), the user enters credit card information (3306), the user previews the information (3308), the user views the receipt (3310), the system emails the receipt and account information to the user's email address (3312). The user downloads the digiclick toolbar (3314), the user installs the toolbar (3316), the installer asks for a phone number (3318), the user submits the phone number (3320), the system emails a PIN for phone registration (3322), the user checks email and clicks on verification link (3324), the system initiates call to phone number (3326), the user picks up the phone and enters PIN (3328), the system registers the user's phone number (3330). The user launches the toolbar and begins using service (3332).

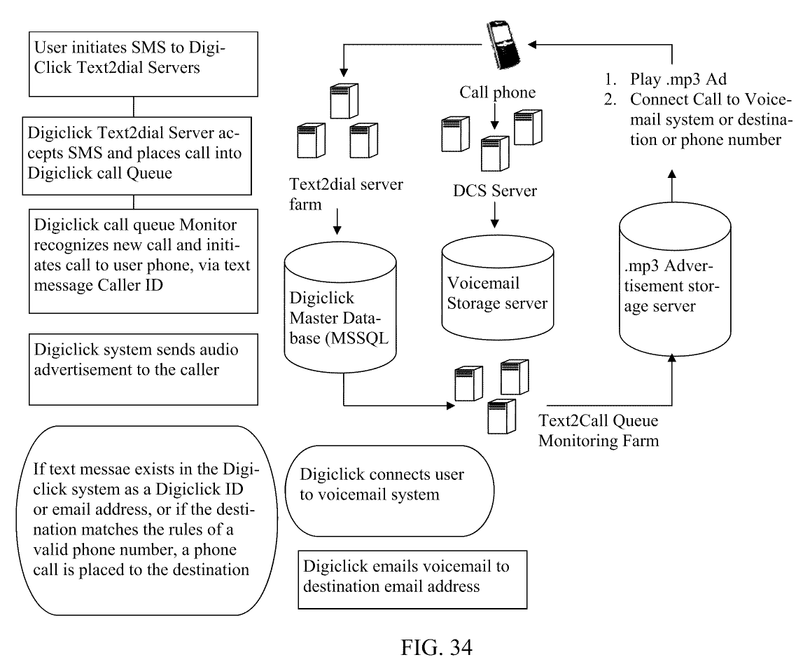

FIG. 34 depicts a method of accepting a voicemail. As shown, the first user initiates SMS to the system servers, the server accepts the request containing at least one email and places a call into the call queue. The call queue recognizes a new call and calls the first user (may be via text message callerID). The system may or may not send an advertisement to the caller. The advertisement may be sent via email, computer, text message or audio on the telephone call. Once the system calls the first user, an indicator that the system is accepting a voicemail may play. For example, it may say “Please record your message at the tone” and a tone may ring. The system then accepts the voicemail message, converts it into a email format and emails it to the email address. The call request may be made or requested through a web page input, mobile device input, or any other input device.

It should be understood that the foregoing relates to preferred embodiments of the invention and that modifications may be made without departing from the spirit and scope of the invention as set forth in the following claims.

I claim:

1. A computer implemented method of sending a voicemail through a web page input, said method comprising the steps of:
providing a first user having a first user ID associated with a first phone number;
accepting an voicemail request from said first user containing at least one email address;
receiving in a computer based system said voicemail request and said computer based system places a telephone call to said first phone number;
playing an advertisement to said first user;
recording a voicemail from said first user; and
emailing an email containing at least one word of transcribed text from said voicemail to said email address.

2. A method as in claim 1, wherein said step of playing an
advertisement is played on at least one of said first user's cell phone, said first user's computer and said first user's hand held device.

3. A method as in claim 1, further comprising the step of:
Emailing a copy of said voicemail to said first user's email address.

4. A method as in claim 1, further comprising the step of:
rating said voicemail.

5. A method as in claim 1, further comprising the step of:
Attaching a sound file to said email, said sound file being a recording of said voicemail.

6. A method as in claim 5, wherein said sound file is selected from the group consisting of: wav, mp3, aiff and au.

7. A computer implemented method of sending a voicemail through a web page input, said method comprising the steps of:
providing a first user having a first user ID associated with a first phone number;
initiating short messaging service (SMS) to at least one system server;
accepting a voicemail request from said first user containing at least one destination email address;
receiving in said at least one system server said voicemail request and saving said voicemail request in a call queue;
calling said first phone by said at least one system server;
playing an advertisement to said first user;
recording a voicemail from said first user; and
transcribing the content of said voicemail to text to provide a transcribed message;
emailing said destination email address said transcribed message.

8. A method as in claim 7, wherein said step of playing an advertisement is played on at least one of said first user's cell phone, said first user's computer and said first user's hand held device.

9. A method as in claim 7, further comprising the step of:
Emailing a copy of said voicemail to said first user's email address.

10. A method as in claim 7, further comprising the step of:
rating said voicemail.

11. A method as in claim 7, further comprising the step of:
Attaching a sound file to said email, said sound file being a recording of said voicemail.

12. A method as in claim 7, wherein said sound file is selected from the group consisting of: wav, mp3, aiff and au.

13. A system for sending a voicemail through a web page input, said system comprising:
at least one initiating phone apparatus;
at least one master database;
at least one server farm;
at least one text server farm;
a web page;
at least one queue monitoring farm;
at least one communications server;
at least one voicemail storage server; and
wherein a first user having a first telephone number inputs a voicemail request into at least a portion of said webpage including a destination email address, said at least one text server farm determines at least one available server in said at least one server farm, said available server accepts said voicemail request and determines from said master database said first user's plan and determines the advertisement status, said voicemail request and said advertisement status is placed in said queue monitoring farm, said at least one server farm calls said first telephone number, said at least one communications server plays an advertisement according to said advertisement status, upon completion of said advertisement said at least one server farm accepts and records a voice recording from said first user, said voice recording is transcribed by said communications server to provide a transcribed voicemail and said transcribed voicemail is sent by email to said destination email address.

14. A system as in claim 13, wherein said advertisement status is selected from the group consisting of: free, free and international, paid, paid and international.

15. A system as in claim 13, further comprising:
A toolbar for accepting said voicemail request, wherein one of said at least one load balancer determines an available server.

16. A system as in claim 13, further comprising:
At least one load balancer wherein said first user sends a voicemail request
via said telephone apparatus and said one of said at least one load balancer determines an available server.

17. A system as in claim 13, further comprising:
a scripting server for providing messages to users.
